(19) United States
(12) Patent Application Publication
(10) Pub. No.: US 2014/0027993 A1
(43) Pub. Date: Jan. 30, 2014

(54) TENT BAG

(71) Applicant: YU CHIEH LEE, TAINAN (TW)

(72) Inventor: YU CHIEH LEE, TAINAN (TW)

(21) Appl. No.: 13/558,937

(22) Filed: Jul. 26, 2012

(51) Int. Cl. B62B 1/00

(52) U.S. Cl. 280/47.131

(57) ABSTRACT

A tent bag includes a soft bag body, a base, and at least one wheel. The base has a top side defining a supporting surface, the soft bag body is fixedly connected to and supported on the supporting surface of the base, and the wheel is located adjacent to a first transverse side of the base. With the top side of the base forming a supporting surface for fixedly connecting to and supporting the soft bag body thereon and with the wheel located adjacent to the transverse side of the base, the tent bag has good mobility and can be conveniently and effortlessly transported. Further, since the bottom of the soft bag body is supported on the base, it would not become collapsed downward even under the weight of a folded tent received therein, and therefore would not frictionally contact with the ground when the tent bag is being pulled.

### FIELD OF THE INVENTION

The present invention relates to a bag, and more particularly to a tent bag having a soft bag body and a base for supporting the soft bag body thereon.

### BACKGROUND OF THE INVENTION

Following the rapid economic development and the quickly upgraded living standard, more and more people select to relax themselves during weekends or holidays by having fun in outdoor activities, such as camping. A tent is no doubt necessary in camping. To enable convenient carrying thereof, the tent is usually foldable to be received in a tent bag. FIG. 1 is a perspective view of a conventional tent bag that is currently available in the market, it includes a soft bag body 10′, at least one connection bracket 30′, and at least one wheel 40′. The connection bracket 30′ is fixedly connected to a lower front side of the soft bag body 10′, and the wheel 40′ is mounted to the connection bracket 30′. To transport the tent bag, a user may walk while manually pulling an upper front side of the soft bag body 10′. Being pulled in this manner, the soft bag body 10′ would incline forward with the wheel 40′ rotatably contacted with the ground. With the wheel 40′, the tent bag is provided with mobility, allowing the user to conveniently move the tent bag and the folded tent received therein with less energy. However, since the soft bag body has a soft bottom, and the connection bracket is provided only on the lower front side of the soft bag body, the bottom of the soft bag body tends to collapse downward under the weight of the folded tent received in the tent bag. The downward collapsed soft bag bottom would possibly frictionally contact with the ground when the tent bag is being pulled, which necessitates the user to pull the tent bag with more energy and would disadvantageously cause damage to the tent bag or even the folded tent received therein.

### SUMMARY OF THE INVENTION

A primary object of the present invention is to provide an improved tent bag that allows a user to effortlessly pull it and prevents a soft bag body thereof from contacting with the ground and becoming damaged when the tent bag is being pulled, so as to overcome the problems in the conventional tent bag.

To achieve the above and other objects, the tent bag according to an embodiment of the present invention includes a soft bag body, a base, and at least one wheel. The base has a top side defining a supporting surface for fixedly connecting to and supporting the soft bag body thereon. The wheel is located adjacent to a first transverse side of the base.

According to a preferred embodiment of the present invention, the soft bag body is fixedly connected at a bottom to the supporting surface of the base, and the bottom of the soft bag body has an area generally equal to that of the supporting surface of the base.

In a preferred embodiment of the present invention, the tent bag further includes a connection bracket, which is fixedly connected to the first transverse side of the base to locate higher than the supporting surface, and the at least one wheel is installed on the connection bracket.

In a preferred embodiment of the present invention, the connection bracket includes a mounting plate. The mounting plate is fixedly connected at a lower side to the first transverse side of the base, and is provided on an upper side facing away from the base with a plurality of horizontally equally spaced locating plates. The wheel is rotatably installed on between any two adjacent locating plates.

In a preferred embodiment of the present invention, the connection bracket further includes a left auxiliary plate fixedly connected to between a left side of the mounting plate and a left side of the base, and a right auxiliary plate fixedly connected to between a right side of the mounting plate and a right side of the base.

In a preferred embodiment of the present invention, the base is a frame having three parallel and equally spaced longitudinal bars extended between and connected to two parallelly spaced transverse bars, and a top side of the frame defines the supporting surface.

In a preferred embodiment of the present invention, the base and the connection bracket are integrally formed with each other.

In a preferred embodiment of the present invention, the left and the right auxiliary plate both have a rear edge configured as a concave curve.

With the top side of the base forming a supporting surface for fixedly connecting to and supporting the soft bag body thereon and with the wheel located adjacent to the transverse side of the base, the tent bag has good mobility and can be conveniently and effortlessly transported. Further, since the bottom of the soft bag body is supported on the base, it would not become collapsed downward even under the weight of a folded tent received therein, and therefore would not frictionally contact with the ground when the tent bag is being pulled.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional tent bag;

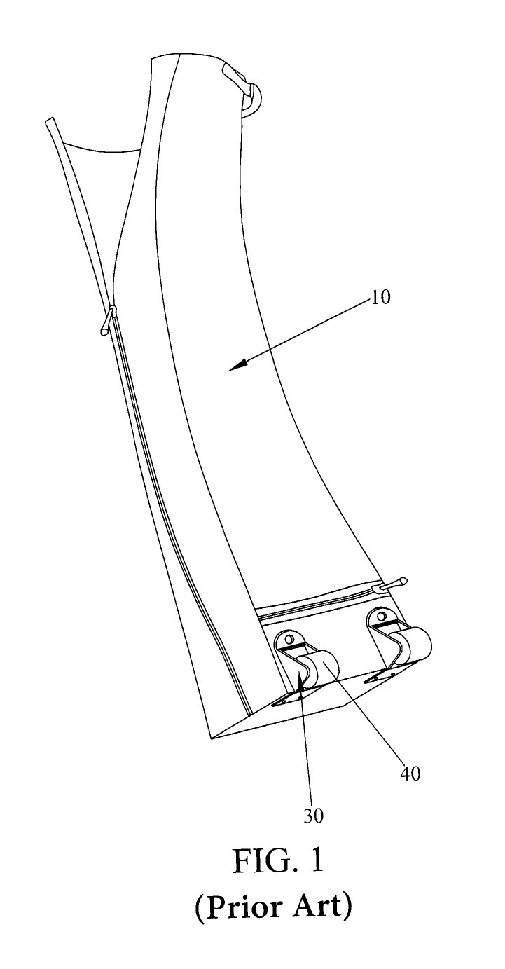

FIG. 2 is a perspective view of a tent bag according to a first embodiment of the present invention; and

FIG. 3 is a perspective view of a tent bag according to a second embodiment of the present invention.

### DETAILED DESCRIPTION OF THE PREFERRED EMBODIMENTS

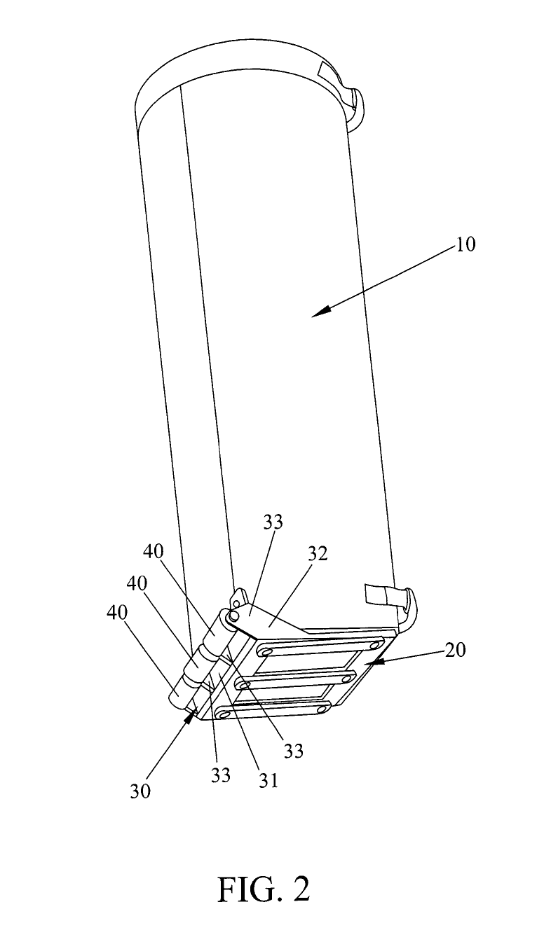

Please refer to FIG. 2 that is a perspective view of a tent bag according to a first embodiment of the present invention. As shown, the tent bag in the first embodiment includes a soft bag body 10, a base 20, a connection bracket 30, and three wheels 40.

The soft bag body 10 has a top opening, around a peripheral edge of which a fastening string is provided for openably closing the top opening. The base 20 is a frame having three parallel and equally spaced longitudinal bars extended between and connected to two parallelly spaced transverse bars. A top side of the frame defines a supporting surface. The soft bag body 10 has a bottom fixedly connected to the supporting surface of the base 20. The bottom of the soft bag body 10 has an area generally equal to that of the supporting surface of the base 20.

The connection bracket 30 includes a mounting plate 31 and a left and a right auxiliary plate 32. The mounting plate 31 has a lower side fixedly connected to a first transverse bar of the base 20 to locate higher than the supporting surface of the base 20. The left auxiliary plate 32 is fixedly connected to between a left side of the mounting plate 31 and a left side of the base 20; and the right auxiliary plate 32 is fixedly connected to between a right side of the mounting plate 31 and a right side of the base 20. The left and right auxiliary plates 32 both have a rear edge configured as a straight sloping line. Further, the mounting plate 31 is provided on an upper side facing away from the base 20 with four horizontally equally spaced locating plates 33. Between any two adjacent locating plates 33, there is rotatably installed one wheel 40. A pivot shaft is transversely extended through the four locating plates 33 and the three wheels 40.

The base 20 and the connection bracket 30 may be integrally formed with each other.

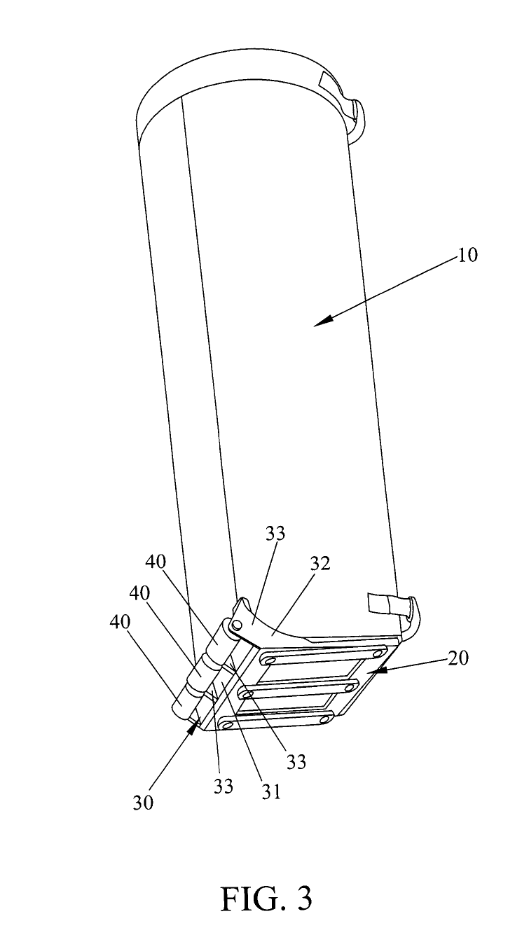

FIG. 3 is a perspective view of a tent bag according to a second embodiment of the present invention. As shown, the second embodiment is different from the first embodiment in that the left and the right auxiliary plate 32 both have a rear edge configured as a concave curve to provide further increased connection strength.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A tent bag, comprising a soft bag body, a base, and at least one wheel; the base having a top side defining a supporting surface, the soft bag body being fixedly connected to and supported on the supporting surface of the base, and the wheels being located adjacent to a first transverse side of the base.

2. The tent bag as claimed in claim 1, wherein the soft bag body is fixedly connected at a bottom to the supporting surface of the base, and the bottom of the soft bag body having an area generally equal to that of the supporting surface of the base.

3. The tent bag as claimed in claim 2, further comprising a connection bracket; the connection bracket being fixedly connected to the first transverse side of the base to locate higher than the supporting surface, and the at least one wheel being installed on the connection bracket.

4. The tent bag as claimed in claim 3, wherein the connection bracket includes a mounting plate; the mounting plate being fixedly connected at a lower side to the first transverse side of the base, and being provided on an upper side facing away from the base with a plurality of horizontally equally spaced locating plates; and
the wheel being rotatably installed on between any two adjacent locating plates.

5. The tent bag as claimed in claim 4, wherein the connection bracket further includes a left auxiliary plate fixedly connected to between a left side of the mounting plate and a left side of the base, and a right auxiliary plate fixedly connected to between a right side of the mounting plate and a right side of the base.

6. The tent bag as claimed in claim 1, wherein the base is a frame having three parallel and equally spaced longitudinal bars extended between and connected to two parallelly spaced transverse bars, and a top side of the frame defining the supporting surface.

7. The tent bag as claimed in claim 4, wherein the base and the connection bracket are integrally formed with each other.

8. The tent bag as claimed in claim 5, wherein the left and the right auxiliary plate both have a rear edge configured as a concave curve.
